(19) United States
(12) Patent Application Publication
(10) Pub. No.: US 2012/0068041 A1
(43) Pub. Date: Mar. 22, 2012

(54) DEVICE FOR PROTECTING THE HOUSING OF A WELDING COMPONENT

(75) Inventors: Günther Flattinger, Pasching (AT); Julia Huemer, Kirchdorf (AT); Peter Oberroither, Wels (AT); Friedrich Oberzaucher, Wels (AT); Manfred Stadler, Pettenbach (AT)

(73) Assignee: FRONIUS INTERNATIONAL GMBH, Pettenbach (AT)

(21) Appl. No.: 13/262,679

(22) PCT Filed: Apr. 28, 2010
(86) PCT No.: PCT/AT2010/000134

§ 371 Date: Oct. 3, 2011

(30) Foreign Application Priority Data
May 18, 2009 (AT) A 776/2009

(51) Int. Cl. F16M 1/00

(52) U.S. Cl. 248/672

(57) ABSTRACT

The invention relates to a device for protecting the housing (26) of a welding component while changing the position thereof, wherein a drag protection (27) in the form of a plate (28) is provided for fastening and for protecting the housing (26), which plate (28) is provided on an outer side (29) with elevations (30) for reducing a bearing surface and a friction resistance.

The invention relates to a device for protecting the housing of a welding component while changing the position thereof.

The present invention, in particular, relates to a protection device for housings of welding components whose positions are changed by a welder. For instance, in welding processes it frequently happens that a user transports components such as, for instance, a welding wire reel or a wire feeder to the welding location by dragging behind the respective component. When pulling or pushing components on the ground, these will become damaged.

The object of the invention resides in providing the optimum protection for a housing and the component disposed therein, as these are being drawn or pulled over the ground by a welder.

The object of the invention comprises a drag protection in the form of a plate for fastening and for protecting the housing, which plate on an outer side, or a side facing away from the housing to be protected, is provided with elevations for reducing a bearing surface and a friction resistance. In this respect, it is advantageous that the housing can, for instance, be pushed or pulled on the ground or floor to a position suitable for a welding procedure, without damaging the housing. The paint of the housing will thus not become damaged, and the housing will continue to remain protected, particularly against corrosion. The drag protection will, moreover, provide a stable support in case the housing is tilted aside. A wire feeder can, for instance, be tilted onto the drag protection to exchange the wire roller disposed therein.

In an advantageous manner, the elevations are adapted to the direction of the change of position to be expected. Such elevations are elements that are simple to realize in order to reduce the bearing surface and the friction resistance.

If the elevations have conically shaped cross sections, a reduction of the friction resistance will advantageously be achieved. Such elevations also offer the advantage that it will not be easily possible to inadvertently change the position of the housing, as would, for instance, be the case with rollers.

The fixation of the drag protection is preferably effected via the inner side, or the side facing the housing to be protected. The inclination of the drag protection can be adjusted by suitable design. By detachably fixing the drag protection, the latter can be easily exchanged.

In an advantageous manner, the measure that the elevations are detachably fastened to the drag protection will enable the drag skids to be individually replaced. Another material which, for instance, even further reduces the friction resistance or wears more slowly can, therefore, also be used for the drag skids.

The shape of the drag protection is preferably adapted to the shape of the housing to be protected, for instance to the shape of a side wall of the housing to be protected.

Further advantages can be taken from the description.

The present invention will be explained in more detail by way of the attached, schematic drawings, wherein the disclosures contained in the whole description can be transferred to identical parts bearing the same reference numerals mutatis mutandis. Furthermore, individual characteristic features from the illustrated exemplary embodiment(s) can also constitute independent solutions according to the invention.

In the drawings:

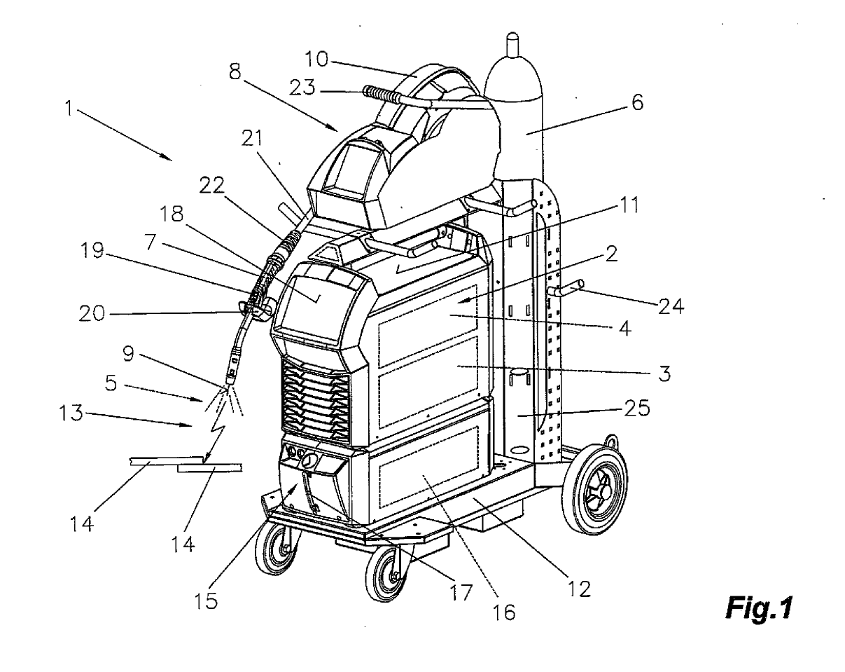

FIG. 1 is a schematic illustration of a welding installation or welding apparatus;

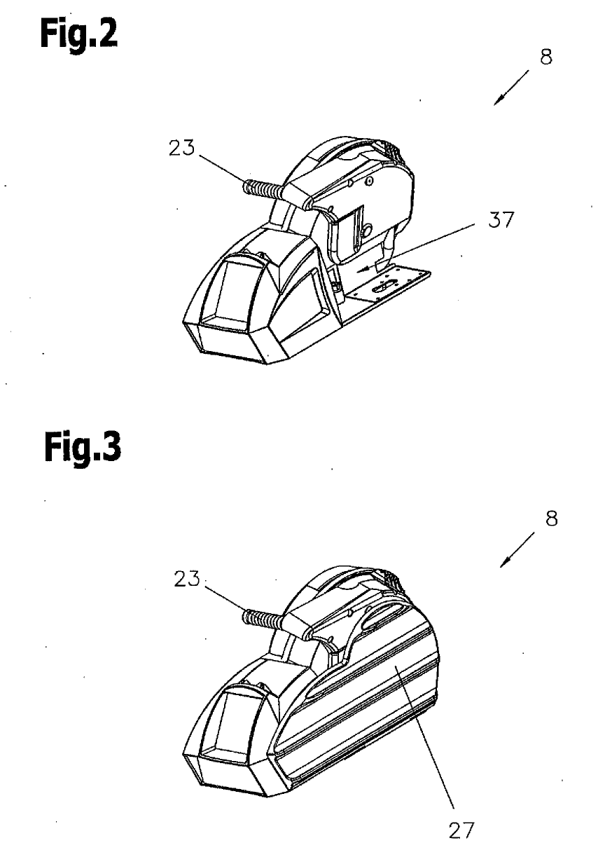

FIG. 2 is a schematic illustration of a wire feeder in an oblique view;

FIG. 3 is a schematic illustration of the wire feeder comprising the drag protection according to the invention, in an oblique view;

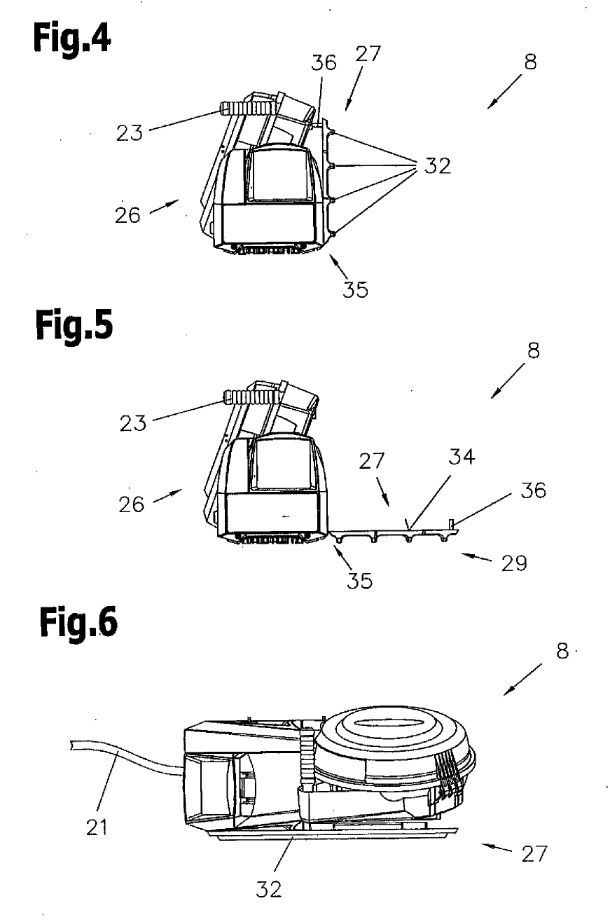

FIG. 4 is a schematic illustration of the wire feeder comprising the drag protection according to the invention, in front view;

FIG. 5 is a schematic illustration of the wire feeder comprising the unfolded drag protection according to the invention, in front view;

FIG. 6 is a schematic illustration of the wire feeder tilted on the drag protection according to the invention;

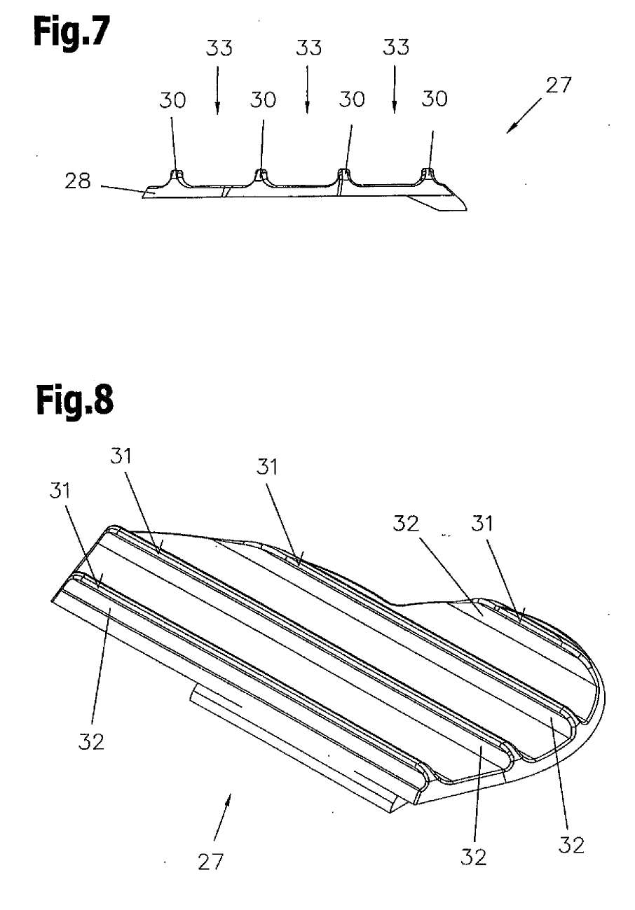

FIG. 7 is a schematic sectional view of the drag protection; and

FIG. 8 is a three-dimensional, schematic illustration of the drag protection.

To begin with, it is noted that identical parts of the exemplary embodiment are provided with the same reference numerals.

FIG. 1 depicts a welding apparatus 1, or welding installation, for various processes or methods such as, e.g., MIG/MAG welding or WIG/TIG welding, or electrode welding methods, double-wire/tandem welding methods, plasma or soldering methods etc.

The welding apparatus 1 comprises a power source 2 including a power element 3 disposed therein, a control device 4, and further components and lines such as a switch member, control valves etc., which are not illustrated. The control device 4 is, for instance, connected with a control valve arranged in a feed line for a gas 5, in particular a protective gas such as, for instance, carbon dioxide, helium or argon and the like, between a gas reservoir 6 and a welding torch 7 or a torch.

In addition, a wire feeder 8, which is usually employed in MIG/MAG welding, can be activated by the control device 4, wherein a filler material or a welding wire 9 is fed from a storage drum 10, or a wire reel, into the region of the welding torch 7 via a feed line. It is, of course, possible to integrate the wire feeder 8 in the welding apparatus 1 and, in particular, in the housing 11 of the power source 2, as is known from the prior art, rather than designing the same as an accessory device placed on a movable carriage 12 as illustrated in FIG. 1. In this respect, it is also possible to place the wire feeder 8 directly on the welding apparatus 1, i.e. design the upper side of the housing 11 of the power source 2 so as to receive the wire feeder 8, in which case the movable carriage 12 may be omitted. For positioning the wire feeder 8, the latter comprises a handle 23.

It is also possible for the wire feeder 8 to supply the welding wire 9 or filler material, to the process site outside the welding torch 7, to which end a non-consumable electrode is preferably arranged within the welding torch 7, as is usually the case with WIG/TIG welding.

The power required for building up an electric arc 13, in particular an operative electric arc, between the electrode, or welding wire 9, and a workpiece 14 preferably comprised of one or several parts is supplied from the power element 3 of the power source 2 to the welding torch 7, in particular the electrode or the welding wire 9, via a welding line, not illustrated, wherein the workpiece 14 to be welded, via a further welding line for the further potential, particularly the ground cable, is connected with the power source 2, not illustrated, so as to enable a power circuit for a process to build up over the electric arc 13, or the plasma jet formed. When using a torch having an internal electric arc 13, the two welding lines, not illustrated, are conducted to the torch so as to enable a suitable power circuit to build up within the torch, as may be the case with plasma burners.

For cooling the welding torch 7, the welding torch 7 can be connected to a fluid reservoir, in particular a water reservoir 16 including a level indicator 17, via a cooling device 15, by interposing possible components like a flow control, wherein, when initiating the welding torch 7 of the cooling device 15, a fluid pump used for the fluid contained in the water reservoir 16 is, in particular, started in order to enable cooling of the welding torch 7. As is shown in the illustrated exemplary embodiment, the cooling device 15 is positioned on the movable carriage 12, with the power source 2 being subsequently placed thereon. The individual components of the welding installation, i.e. the power source 2, the wire feeder 8 and the cooling device 15, are configured in such a manner as to comprise corresponding projections and recesses to enable their stacking or placing on each other.

The welding apparatus 1, in particular the power source 2, further comprises an input and/or output device 18, via which the most diverse welding parameters, operating modes or welding programs of the welding apparatus 1 can be set or called and indicated, respectively. In doing so, the welding parameters, operating modes or welding programs set via the input and/or output device 18 are transmitted to the control device 4, which will subsequently activate the individual components of the welding installation or welding apparatus 1 and/or preset the respective values required for control. In doing so, it is also possible that, when using a respective welding torch 7, setting procedures can also be effected via the welding torch 7, to which end the welding torch 7 is equipped with a welding torch input and/or output device 19. In a preferred manner, the welding torch 7 in this case is connected to the welding apparatus 1 and, in particular, the power source 2 or the wire feeder 8 via a data bus, in particular a serial data bus. To start the welding process, the welding torch 7 in most cases comprises a starter switch, not illustrated, such that the electric arc 13 can be ignited by operating the starter switch. In order to be protected against the strong heat radiation from the electric arc 13, the welding torch 7 may be equipped with a heat protection shield 20.

In the exemplary embodiment illustrated, the welding torch 7 is further connected with the welding apparatus 1 or welding installation via a hose pack 21, said hose pack 21 being fastened to the welding torch 7 via an anti-buckling means 12. The hose pack 21 houses the individual lines such as, for instance, the supply line(s) for the welding wire 9, for the gas 8, for the cooling circuit, for data transmission etc., leading from the welding apparatus 1 to the welding torch 7, whereas the ground cable is preferably separately connected to the power source 2. The hose pack 21 is connected to the power source 2 or the wire feeder 8 via a coupling device, not illustrated, whereas the individual lines in the hose pack 21 are fastened to or in the welding torch 7 by the aid of an anti-buckling means. In order to ensure an appropriate strain relief of the hose pack 21, the hose pack 21 can be connected to the housing 11 of the power source 2 or the wire feeder 8 via a strain relief device, not illustrated.

It should basically be noted that not all of the previously mentioned components need to be used or employed for the various welding methods or welding apparatus 1, such as, e.g., WIG devices or MIG/MAG apparatus or plasma devices. Thus, it is, for instance, possible to devise the welding torch 7 as an air-cooled welding torch 7 such that the cooling device 15 may, for instance, be omitted. It can thus be said that the welding apparatus 1 at least comprises the power source 2, the wire feeder 8 and the cooling device 15, wherein a common housing 11 may also be provided for the same. It is further possible to provide or use even further parts or components such as, e.g., optional carriers 24, a retaining means 25 for the gas reservoir 6, etc.

From the prior art, it is thus generally known that a welder for MIG/MAG welding at least requires the welding apparatus 1, the wire feeder 8 and the hose pack 21 with the welding torch 7. For many applications such as, for instance, in a dockyard or work on a construction site, the welding apparatus 1 is positioned in a protected place such that the welder is on his workplace substantially with the wire feeder 8 and the welding torch 7. The hose pack 21 is accordingly connected to the wire feeder 8 and the wire feeder 8 is connected to the welding apparatus 1. Hence results that the size of the workplace is defined by the position of the wire feeder 8 and the length of the hose pack 21. Welding outside the workplace will accordingly call for a change in the position of the wire feeder 8. In practice, this is effected in that the welder pulls on the hose pack 21, or on the welding torch 7, so as to take along the wire feeder 8. This will be possible until the line connecting the wire feeder 8 to the welding apparatus 1 is taut. In order to prevent the wire feeder 8 from inadvertently changing its position, the wire feeder 8 preferably stands on feet disposed on a base plate, rather than on rollers. The floor spaces of the feet are usually made of rubber. When changing the position of the wire feeder 8 by pulling on the hose pack 21, a certain friction resistance between the floor and the feet of the wire feeder 8 will consequently have to be overcome, wherein the wire feeder 8 can slightly tilt and—according to FIG. 2—is subsequently pulled on a side wall of a housing 26. In doing so, the housing 26 of the wire feeder 8 will be damaged.

The invention, therefore, contemplates that a drag protection 27 can be fastened to the housing 26. To this end, the drag protection 27 is comprised of a plate 28 including at least two elevations 30 on an outer side 29, or side facing away from the housing 26 to be protected, in order to reduce the bearing surface and the friction resistance. Each of the elevations forms a surface area 31, whereby the housing 26, which is connected with the drag protection 27, jointly rests on these surface areas 31 and can be pulled without being damaged. The housing 26 can be transported in the same direction in which the welder pulls the hose pack 21.

The drag protection 27 according to the invention will now be described in detail by way of FIGS. 2 to 8, viewed together.

FIG. 3 depicts a drag protection 27, which is fastened to a side wall of the wire feeder 8. The outer side 29 of the plate 28 forming the drag protection 27 comprises several elevations 30 for reducing the bearing surface and the friction resistance. The elevations 30 accordingly rise above the plate 28. The arrangement of the elevations 30 is selected such that the housing 26 can be pulled into a preferred direction without any major friction resistance. The housing 26, and the wire feeder 8, can thus be pulled or dragged on the ground via the drag protection 27. The arrangement is, moreover, selected such that the housing 26 can also stand stably. The elevations 30, for instance, extend over the length of the plate 28 (as illustrated), thus forming so-called drag skids 32. The drag skids 32 extend substantially in parallel, thus touching the ground. Between the drag skids 32, a distance is, moreover, provided so as to further minimize the friction resistance. Since the hose pack 21 is fastened to one end of the longitudinal side of the plate 28, i.e. on the front side of the wire feeder 8, the drag skids extend in the direction of the hose pack 21. The housing 26 will thus move in the direction of the hose pack 21, as the latter is being pulled.

When the housing 26 is tilted from its base plate on the drag skids 32, it can be dragged in a simple manner. In doing so, the housing 26 will not be damaged, and the stress exerted on the connection between the hose pack 21 and the wire feeder 8 will be kept at a minimum due to the strongly reduced friction resistance. The wire feeder 8 is thus placed on the drag skids 32 of the drag protection 27 when being positioned on the work-place such that the housing 26 can be dragged behind later on, if necessary. Due to the fact that the drag skids 32 determine a direction in which the housing 26 can be dragged, also any undesired change of position will be prevented, since dragging or moving transversely to the drag skids 32 will result in a higher friction resistance. In addition, the drag skids 32 in a simple manner will enable any change of direction desired by the welder, since the bearing surface is only very small. The drag skids 32 may have conical, semicircular or any similar cross section by which the friction resistance is further reduced.

The fixation of the drag protection 27 is effected via an inner side 34, or side facing the housing 26 to be protected, of the plate 28, on which respective fastening means 35 are provided. Fastening means 35, for instance, comprise hinges and a clamping mechanism 36. The hinges are basically fastened to the base plate of the housing 26, to which also the feet are fixed, i.e. at the bottom. The clamping mechanism 36 is accordingly disposed on the top, for instance behind the storage drum 10, such that the drag protection 27 can be folded out. The hinges and the drag protection 27 are mutually adapted so as to enable the drag protection 27 to be completely opened. This means that the drag protection 27 will substantially form a line with the ground plate of the housing 26.

The folding-out of the drag protection 27 in a simple manner enables the connection of the supply lines (gas, power, data, air, etc.) of the welding apparatus 1, because accessibility is improved. This is necessary, because the connections 37 for the supply lines are arranged substantially below the handle 23 of the wire feeder 8—i.e. substantially in the center. These connections will, at the same time, be protected by the drag protection 27 both during dragging and with the housing 26 standing.

Due to the option of unfolding, a clamping mechanism 36 can be used, by which the drag protection 27 can be fixed at a defined angle. The welder can thus flexibly adapt the drag protection 27 to the conditions prevailing on the workplace.

It is, however, also possible to fasten the whole drag protection 27 to the housing 26 by several clamping mechanisms 36 such that the drag protection 27 can be slipped onto the housing 26. The fixation of the drag protection 27 is preferably designed to be detachable so as to enable a rapid and simple exchange of the drag protection 27. An exchange will, for instance, be required when the elevations of the drag skids 32 have become worn and are no longer noticeable.

It goes without saying that it is also possible to exchange only the drag skids 32, if the latter are detachably connected with the plate 28. The detachable connection of the drag skids 32 to plate 28 can, for instance, be realized by screw connections or plug-in connections. In this case, it is also possible that the drag skids 32 are made of a different material than the plate 28. The drag skids 32 can thus, for instance, be adapted to the nature of the ground.

Nor is the drag protection 27 limited to being fixed to the side wall of the housing 26. The drag protection 27 can also be fastened to the base plate or to a lid of the housing 26. In a preferred manner, the drag protection 27 is fastened to that side wall of the housing 26 which includes the center of gravity of the housing 26. It will thereby be ensured that the risk of overturning during dragging will be minimized.

The shape of the drag protection 27 is preferably adapted to the shape of that side wall of the housing 26 to which the drag protection is to be fixed. Besides, the outer appearance will substantially remain unchanged. This will further safeguard that the housing 26 will also stably stand on the drag skids 32. In order to ensure this stability even with a small housing 26, the drag protection 27 may, of course, be configured to be larger than the housing 26. According to demands, the drag protection 27 may, of course, also be smaller than the housing 26, or have a shape differing from that of the housing 26.

Furthermore, the drag protection 27, for instance, also enables a very simple exchange of the storage drum 10 of the wire feeder 8, since this can be done from top rather than from aside.

It goes without saying that a drag protection 27 may simultaneously be each attached to the left-hand side wall, the right-hand side wall and the bottom of the base plate of the housing 26. The housing 26 can thus be pulled substantially in any position without being damaged. Correspondingly, also a single drag protection 27 can be used for the two side walls and the base plate.

The drag protection 27 can, moreover, be fastened to a side of a housing 11 of the welding apparatus 1, or power source 2. This will, for instance, be the case with a so-called electrode welding apparatus, which does not require a wire feeder 8.

To sum up, it can be said that the device according to the invention provides the opportunity to drag a housing 26, or a housing 11, over the ground without damaging the housing 26. Small obstacles on the ground will, moreover, not constitute any problem, since they will be urged between the drag skids 32.

1. A device for protecting the housing (26) of a welding component while changing the position thereof, wherein a drag protection (27) in the form of a plate (28) is provided for fastening and for protecting the housing (26), which plate (28) is provided on an outer side (29) with elevations (30) for reducing a bearing surface and a friction resistance.

2. A device according to claim 1, wherein the elevations (30) are adapted to the direction of the change of position to be expected.

3. A device according to claim 1, wherein the elevations have conically shaped cross sections.

4. A device according to claim 1, wherein each of the elevations (30) extends over the length of the drag protection (27), and the elevations (30) are disposed in a mutually spaced-apart manner (33).

5. A device according to claim 1, wherein means (35) for fastening the drag protection (27) to the housing (26) are disposed on an inner side of the same.

6. A device according to claim 5, wherein fastening means (35) for detachably fastening the drag protection (27) to the housing (26) are provided.

7. A device according to claim 1, wherein the elevations (30) are detachably fastened to the drag protection (27).

8. A device according to claim 1, wherein the shape of the drag protection (27) is adapted to the shape of the housing (26) to be protected.

9. A device according to claim 8, wherein the drag protection (27) is adapted to the shape of a side wall of the housing (26) to be protected.
